(19) United States
(12) Patent Application Publication
(10) Pub. No.: US 2016/0190651 A1
(43) Pub. Date: Jun. 30, 2016

(54) NONAQUEOUS ELECTROLYTE BATTERY AND BATTERY PACK

(71) Applicant: KABUSHIKI KAISHA TOSHIBA, Tokyo (JP)

(72) Inventors: Hiroki INAGAKI, Yokohama (JP); Norio TAKAMI, Yokohama (JP)

(73) Assignee: KABUSHIKI KAISHA TOSHIBA, Tokyo (JP)

(21) Appl. No.: 15/065,162

(22) Filed: Mar. 9, 2016

Related U.S. Application Data
(63) Continuation of application No. PCT/JP2013/075206, filed on Sep. 18, 2013.

(51) Int. Cl. H01M 10/0567; H01M 10/0525; H01M 2/34; H01M 4/48; H01M 4/485

(52) U.S. Cl. CPC H01M 10/0567; H01M 4/48; H01M 4/485; H01M 2/34; H01M 10/0525; H01M 2220/20

(57) ABSTRACT

According to one embodiment, a nonaqueous electrolyte battery includes a positive electrode, a negative electrode and a nonaqueous electrolyte. The negative electrode contains a negative electrode active material having a Li insertion/extraction potential of 0.4 V (vs. Li/Li⁺) or more. The nonaqueous electrolyte is a liquid at 20 degrees Celsius and 1 atom and contains a silicon compound having an isocyanate group or an isothiocyanate group.

### CROSS-REFERENCE TO RELATED APPLICATIONS

This application is a Continuation Application of PCT Application No. PCT/JP2013/075206, filed Sep. 18, 2013, the entire contents of which are incorporated herein by reference.

### FIELD

Embodiments of the present invention relates to a nonaqueous electrolyte battery and a battery pack.

### BACKGROUND

Recently, nonaqueous electrolyte batteries which use titanium composite oxides (Li₄Ti₅O₁₂) having a cubic crystal system spinel structure for negative electrode active materials have been studied. A Li insertion/extraction potential of the titanium composite oxide is about 1.5 V (vs. Li/Li⁺) which is higher than a Li insertion/extraction potential of about 0.1 V (vs. Li/Li⁺) of a carbon negative electrode active material, and deposition of Li metal is difficult to occur in principle. Accordingly, batteries which use the titanium composite oxides for negative electrodes degrade the performance little even if repeatedly charge and discharge at large current and may exhibit a high safety. Li or Li ion is inserted to and/or extracted from the niobium composite oxide at about 1.5 V (vs. Li/Li⁺) similarly to the titanium composite oxide and can thus exhibit a high safety. When Li is inserted to, the valence of titanium changes from Ti⁴⁺ to Ti³⁺ and the valence of niobium changes from Nb⁵⁺ to Nb³⁺, thus enabling the niobium composite oxide to obtain the volume nearly twice as large as that of the titanium composite oxide, and easily attaining high-energy density of batteries.

On the other hand, while advancing the increase in size and capacity of on-vehicle and stationary batteries etc., safer batteries are required, and batteries using the titanium composite oxide and niobium composite oxide are expected to be improved so as to hardly generate the heat.

### BRIEF DESCRIPTION OF THE DRAWINGS

FIG. 1 shows a sectional schematic view of a flat-type nonaqueous electrolyte battery as one example of Embodiment 1.

FIG. 2 shows an enlarged sectional view of Part A in FIG. 1.

FIG. 3 shows a schematic partially notched perspective view of other nonaqueous electrolyte battery according to Embodiment 1.

FIG. 4 shows a sectional schematic view of Part B in FIG. 3.

FIG. 5 shows an exploded perspective view of a battery pack as one example of Embodiment 2.

FIG. 6 shows a block diagram illustrating an electric circuit of a battery pack in FIG. 5.

### DETAILED DESCRIPTION

According to Embodiment 1, a nonaqueous electrolyte battery is provided. This nonaqueous electrolyte battery contains a positive electrode, a negative electrode and a nonaqueous electrolyte. The negative electrode contains the negative electrode active material having a Li insertion/extraction potential of 0.4 V (vs. Li/Li⁺) or more. The nonaqueous electrolyte is a liquid at 20 degrees Celsius and 1 atom, and contains a silicon compound having an isocyanate group and an isothiocyanate group. One sort of the isocyanate group or the isothiocyanate group may be used alone or two sorts or more may be used in combination.

According to Embodiment 2, a battery pack is provided. This battery pack includes the nonaqueous electrolyte battery according to Embodiment 1.

Hereinafter, embodiments will be explained with reference to drawings. In this case, the same reference signs will be assigned to components which fulfill the same or similar functions throughout all the figures, and overlapping explanation will be omitted in the following explanation. The respective drawings are schematic drawings for promoting explanation of embodiments and their understanding, and shapes, sizes, and ratios etc. thereof may be different from those of the actual equipment, but their design may be modified as necessary, making reference to the following explanation and the prior art.

### Embodiment 1

According to Embodiment 1, a nonaqueous electrolyte battery is provided. This nonaqueous electrolyte battery contains a positive electrode, a negative electrode and nonaqueous electrolyte. The negative electrode contains the negative electrode active material having a Li insertion/extraction potential of 0.4 V (vs. Li/Li′) or more. The nonaqueous electrolyte is a liquid at 20 degrees Celsius and 1 atom, and contains a silicon compound having an isocyanate group and an isothiocyanate group.

For example, in case of using negative electrode active materials such as titanium composite oxide that Li or Li ion can be inserted to and/or extracted from at a high potential, for example 1.5 V, a stable film is hardly formed on the negative electrode active material surface, and a battery is then exposed in a high-temperature environment, an electrolyte solution might decompose on the negative electrode surface excessively to generate the heat. This decomposition reaction is remarkable at nearly 150 degrees Celsius, and then if a battery is exposed to an abnormal state like overcharge, this heat generation might trigger the inducement of the thermal runaway of a positive electrode, and consequently the battery might generate the abnormal heat. Such heat generation is much smaller than that in case of using the carbon negative electrode active material, but the heat generation of the negative electrode which may induce the thermal runaway of the positive electrode is preferably kept to minimum as much as possible.

The present inventors then intensively studied to find that the nonaqueous electrolyte battery using the negative electrode active material like a Li-titanium composite oxide having a Li insertion/extraction potential of high, specifically 0.4 V (vs. Li/Li⁺) or more and the nonaqueous electrolyte which is a liquid at a room temperature (20 degrees Celsius) and 1 atom in which the silicon compound having the isocyanate group or the isothiocyanate group is added to the nonaqueous electrolyte may suppress decomposition of the nonaqueous electrolyte on the negative electrode surface if the battery is exposed under high-temperature conditions and suppress the accompanying heat generation and consequently increase the safety of the battery.

The detailed chemical reaction is unclear but the silicon compound having the isocyanate group or the isothiocyanate group contained in the nonaqueous electrolyte reacts with the negative electrode active material having a Li insertion/extraction potential of 0.4 V (vs. Li/Li⁺) or more and may then form an organic film on the negative electrode surface, for example, at the initial charging. This organic film may suppress the reaction of the negative electrode active material with a nonaqueous electrolyte supporting salt even if the nonaqueous electrolyte battery is exposed under high-temperature conditions. Thanks to this, the decomposition of the nonaqueous electrolyte may be suppressed and the accompanying heat generation of the negative electrode may be suppressed.

As examples of the silicon compound having the isocyanate group or the isothiocyanate group, trimethylsilyl isocyanate, trimethylsilyl isothiocyanate, (trimethylsilyl)methyl isocyanate, (trimethylsilyl)methyl isothiocyanate, dimethyl silyl isocyanate, methyl silyl triisocyanate, vinyl silyl triisocyanate, phenyl silyl triisocyanate, tetra isocyanate silane, and ethoxy silane triisocyanate etc. may be listed.

The silicon compound having the isocyanate group or the isothiocyanate group of smaller molecular weight is added in smaller amounts may produce a great effect. There is further a smaller risk of the addition in smaller amounts changing the nature of the nonaqueous electrolyte like conductivity.

The silicon compound having the isocyanate group or the isothiocyanate group preferably has trimethylsilyl group. Adding the silicon compound in which the isocyanate group or the isothiocyanate group and the trimethylsilyl group coexist may more suppress the heat generation of the negative electrode in case where the nonaqueous electrolyte battery is exposed to a high temperature. Although the cause is unclear, a silicon compound having the isocyanate group or the isothiocyanate group alone antecedently grows the organic film as explained above, but if the trimethylsilyl group coexists, inorganic compounds such as Li fluoride which is hardly decomposed thermally grows on the negative electrode surface preferentially, which is expected to enhance the effect. Especially, the trimethylsilyl isocyanate, trimethylsilyl isothiocyanate, (trimethylsilyl)methyl isocyanate or (trimethylsilyl)methyl isothiocyanate are preferably used.

The aforementioned effect produced by adding the silicon compound in which the isocyanate group or the isothiocyanate group and the trimethylsilyl group coexist in the nonaqueous electrolyte cannot be obtained even if adding both a compound having the isocyanate group or the isothiocyanate group and a compound having the trimethylsilyl group in the nonaqueous electrolyte. The detailed reason is unclear but the inventors demonstrated this fact through the following Example 1-1 and Comparative Example 1-7.

The silicon compound having the isocyanate group or the isothiocyanate group may be dissolved in a nonaqueous solvent of the nonaqueous electrolyte if it is a solid. Alternatively, the silicon compound having the isocyanate group or the isothiocyanate group which is a liquid may be mixed with the nonaqueous solvent.

The content of the silicon compound having the isocyanate group or the isothiocyanate group is preferably 0.01 mass % to 5 mass % in the nonaqueous electrolyte. Adding the silicone compound in the amount of 0.01 mass % or more forms the precise and stable film on the negative electrode surface and may more suppress the heat generation on the negative electrode surface. Adding the aforementioned silicon compound in the mount of 5 mass % or less may suppress the heat generation of the negative electrode while suppressing the decomposition of the film itself. The more preferable additive amount of the aforementioned silicon compound is 0.03 mass % to 3 mass.

The silicon compound in the nonaqueous electrolyte may be detected using, for example, the gas chromatography-mass spectrometry (GC/MS).

An electrolyte solution subjected to detection is extracted by adjusting a battery to be analyzed to a half charged state (SOC50%), and disassembling in an inert atmosphere such as argon box.

GC/MS may be analyzed by means of, for example, the following method. As the device, the GC/MS (5989B) made by Agilent may be used, and as the measuring column, the DB-5MS (30 m×0.25 mm×0.25 μm) may be used. The electrolyte solution may be directly analyzed and additionally, it can also be measured by diluting with acetone, DMSO etc.

FT-IR may be analyzed by means of, for example, the following method. As the device, Fourier transform FTIR equipment: FTS-60A (made by BioRad Digilab Co., Ltd.) may be used. As measurement conditions, light source: special ceramics, detector: DTGS, wavenumber resolution: 4 cm⁻¹, the number of integrations: 256 times, Reference: a gold evaporation film may be used, as auxiliary equipment, such as diffuse reflectance measuring device (made by PIKE Technologies Co., Ltd.) etc. may be applied.

Subsequently, the nonaqueous electrolyte battery according to Embodiment 1 will be further explained in detail.

The nonaqueous electrolyte battery according to Embodiment 1 further contains a negative electrode, a nonaqueous electrolyte and a positive electrode. The nonaqueous electrolyte battery according to Embodiment 1 may further contain a separator, a container member, a positive electrode terminal and a negative electrode terminal.

The negative electrode and positive electrode may constitute a group of electrodes by allowing the separator to intermediate therebetween. The container member may accommodate the group of electrodes and the nonaqueous electrolyte. The positive electrode terminal may be electrically connected to the positive electrode. The negative electrode terminal may be electrically connected to the negative electrode.

Hereinafter, the negative electrode, nonaqueous electrolyte, positive electrode, separator, container member, positive electrode terminal and negative electrode terminal will be explained in detail.

1) The Negative Electrode

The negative electrode may contain a negative electrode current collector and a negative electrode layer containing an active material formed on one side or both sides of the negative electrode current collector (a negative electrode active material containing layer). The negative electrode layer may contain a conducting agent and a binder.

As the negative electrode active material, a negative electrode active material having a Li insertion/extraction potential of 0.4 V (vs. Li/Li⁺) or more is used. The more effective negative electrode active materials is a negative electrode active material having a Li insertion/extraction potential of 1.0 V (vs. Li/Li⁺) or more. If the Li or Li ion is inserted to a carbonaceous matter etc. at a potential lower than 0.4 V (vs. Li/Li⁺) are used, the silicon compound having the isocyanate group or the isothiocyanate group is reduced and decomposed excessively and a film with high resistance is formed excessively on the negative electrode surface and the battery performance is remarkably reduced. Further in this case, the excessive decomposition reaction of the silicon compound itself increases the heating value of the negative electrode.

A negative electrode active material preferably has the Li insertion/extraction potential of lower than 3 V (vs. Li/Li⁺) to increase the cell potential.

The negative electrode active material is preferably a titanium composite oxide or a niobium composite oxide. The Li or Li ion may be inserted to these composite oxides at nearly 1.5 V (vs. Li/Li⁺) and may thus prevent the silicon compound in the nonaqueous electrolyte from being reduced and decomposed excessively.

Examples of the titanium composite oxide include Li titanium oxide such as Li₄₊ₓTi₅O₁₂ (0≦x≦3 (changing depending upon the charging state) and Li_{2+y}Ti₃O₇ (0≦y≦3 (changing depending upon the charging state), Li titanium composite oxides in which part of constituent elements of Li titanium oxide are replaced with heteroelements.

Examples of the niobium composite oxide include a monoclinic system niobium composite oxide expressed by a general formula LiₓM_{(1-y)}Nb_{y}Mb₂O_{(7+δ)} (in which M is at least one selected from a group consisting of Ti and Zr, and x, y and δ are numerals satisfying 0≦x≦6 (changing depending upon the charging state), 0≦y≦1 and −1≦δ≦1 (changing depending upon, for example, oxygen loss in the synthesis) like LiₓNb₂O₅ (0≦x≦1 (changing depending upon the charging state) and LiₓTiNb₂O₇ (0≦x≦1 (changing depending upon the charging state) having a Li insertion/extraction potential of 1 to 2 V (vs. Li/Li⁺).

Other examples of the negative electrode active material include molybdenum composite oxide having a Li insertion/extraction potential of 2 to 3 V (vs. Li/Li⁺) like LiₓMoO₃ (0≦x≦1 (changing depending upon the charging state)) or iron composite sulfide having a Li insertion/extraction potential of 1.8 V (vs. Li/Li⁺) like LiₓFeS₂ (0≦x≦4 (changing depending upon the charging state)).

As the negative electrode active material, titanium oxide like TiO₂ or metal composite oxides containing at least one element selected from a group consisting of Ti and P, V, Sn, Cu, Ni, Co and Fe may also be used. The Li or Li ion is inserted to these oxides to be formed into Li titanium composite oxides at the initial charging. TiO₂ is preferably monoclinic β-type (bronze type or which shall be also referred to as TiO₂(B)) or preferably an anatase type whose heat treatment temperature is 300 to 500 degrees Celsius and having low crystallinity.

Examples of the metal composite oxide containing at least one element selected from a group consisting of Ti and P, V, Sn, Cu, Ni, Co and Fe include TiO₂—P₂O₅, TiO₂—V₂O₅, TiO₂—P₂O₅—SnO₂, TiO₂—P₂O₅-MeO (Me is at least one element selected from a group consisting of Cu, Ni, Co and Fe). The metal composite oxides have a crystal phase and an amorphous phase which coexist, or preferably has a microstructure in which the amorphous phase exists alone. Such microstructure significantly enhances the recycle performance.

The active materials listed above may be used alone or used by mixture for the negative electrode active material.

The average primary particle size of the negative electrode active material is preferably 1 μm or less. Further, employing the average primary particle size of 0.001 μm or more may reduce the bias of the distribution of the nonaqueous electrolyte, which may prevent the exhaustion of the nonaqueous electrolyte at the positive electrode. Accordingly, the lower limit of the average primary particle size is preferably 0.001 μm or more.

The negative electrode active material preferably has its average primary particle size of 1 μm or less and its specific surface area in the range of 5 to 50 m²/g by means of the BET method using N₂ adsorption. This makes it possible to raise impregnation of the nonaqueous electrolyte.

The larger specific surface area of the negative electrode active material produces the greater effect that the heat generation of the negative electrode may be suppressed if the nonaqueous electrolyte battery according to Embodiment 1 is exposed to the high temperature. This results from the fact that a high affinity of the Li titanium composite oxide and water brings much water in cells if the specific area is larger.

The negative electrode active material may contain a conducting agent. As the conducting agent, for example, metal powders such as carbon material, aluminum powders, or conductive ceramics such as TiO etc. may be used. Examples of the carbon material include acetylene black, carbon black, cokes, carbon fiber and graphite. More preferably, cokes, graphite, TiO powders having the heat treatment temperature of 800 to 2,000 degrees Celsius and the average particle size of 10 μm or less and the carbon fiber having an average particle size of 1 μm or less are used. The carbon material preferably has the BET specific surface area by N₂ adsorption of 10 m²/g or more.

The negative electrode active material containing layer may contain a binder. Examples of the binder include polytetrafluoroethylene (PTFE), polyvinylidene fluoride (PVdF), fluororubbers, styrene-butadiene rubbers, and core-shell binders.

As for the compounding ratio of the negative electrode active material, the negative electrode conductive agent and the binder, the negative electrode active material is preferably from 70 mass % to 96 mass %, the negative electrode conductive agent is preferably from 2 mass % to 28 mass % and the binder is preferably from 2 mass % to 28 mass %. Employing the negative electrode conductive agent of 2 mass % or more may enhance the current collecting performance of the negative electrode active material containing layer and may enhance the large current characteristics of the nonaqueous electrolyte battery. Employing the binder of 2 mass % or more makes the binding property of the negative electrode active material containing layer and the negative electrode current collector sufficient, and produces high cycle characteristics. On the other hand, in view of the increase in capacity, the negative electrode conductive agent and binder preferably have 28 mass % or less respectively.

The negative electrode current collector is preferably an aluminum foil or an aluminum alloy foil. The negative electrode current collector preferably has the average crystalline grain size of 50 μm or less. This may dramatically increase strength of the current collector, which makes it possible that the negative electrode is densified at a high pressing pressure, and may increase the battery capacity. Further deterioration due to decomposition and corrosion of the negative electrode current collector in an over-discharge cycle in the high-temperature environment (at 40 degrees Celsius or more) may be prevented, which may suppress increase in the negative electrode impedance. Further output characteristics, fast charge, and charge-discharge cycle characteristics may be enhanced. The more preferable scope of the average crystalline grain size is 30 μm or less, and more preferable range is 5 μm or less.

The average crystalline grain size is obtained as follows. The tissue of the current collector surface is observed by an electron microscope to obtain the number n of crystal grains present in 1 mm×1 mm. An average crystalline grain area S is obtained from S=1×10⁶/n (μm²) using this n. The average crystalline grain size d (μm) is calculated from the obtained value S using the following formula (C).

d=2(S/π)^{1/2} (C)

The aforementioned crystalline grain size of the aluminum foil or aluminum alloy foil is complexly affected by many factors such as material composition, impurities, processing conditions, thermal treatment history and heating conditions for annealing. The aforementioned average crystalline grain size (diameter) of the aluminum foil or aluminum alloy foil may be adjusted to 50 μm or less by combining these various factors during the production process.

The thickness of the aluminum foil or aluminum alloy foil is 20 μm or less and more preferably 15 μm or less. The purity of the aluminum foil is preferably 99 mass % or more. As the aluminum alloy, alloys containing elements such as magnesium, zinc, silicon are preferable. On the other hand, the content of transition metals such as iron, copper, nickel, chrome is preferably 1 mass % or less.

The porosity of the negative electrode (excluding the current collector) is preferably 20% to 50%. This may provide the high-density negative electrode excellent in an affinity of the negative electrode and nonaqueous electrolyte. The porosity is preferably 25% to 40%.

The density of the negative electrode is preferably 1.8 g/cc or more. This makes it possible that the porosity is within the aforementioned range. The more preferable range of the negative electrode density is 1.8 g/cc to 2.5 g/cc.

The negative electrode is produced by, for example, applying slurry prepared by suspending the negative electrode active material, negative electrode conducting agent and binder in a widely used solvent to the negative electrode current collector, drying it, preparing the negative electrode active material containing layer and then subjecting it to the press.

2) The Nonaqueous Electrolyte

The nonaqueous electrolyte used in Embodiment 1 is a liquid at a room temperature (20 degrees Celsius) and 1 atom which was prepared by dissolving the electrolyte in the nonaqueous solvent. For example, the nonaqueous electrolyte solution may be used. The electrolyte is preferably dissolved in the nonaqueous solvent at a concentration of 0.5 mol/L to 2.5 mol/L.

As explained above, the nonaqueous electrolyte battery in Embodiment 1 contains the silicon compound having the isocyanate group or the isothiocyanate group.

The electrolyte may use, for example, Li salts such as Li perchlorate (LiClO₄), Li hexafluorophosphate (LiPF₆), Li tetrafluoroborate (LiBF₄), Li hexafluoro arsenate (LiAsF₆), Li trifluoromethanesulfonate (LiCF₃SO₃) or Li bis(trifluoromethylsulfonyl)imide [LiN(CF₃SO₂)₂]. Preferably, the electrolyte hardly oxidizes at a high potential, and LiBF₄ or LiPF₆ is the most preferable. One sort of the electrolyte may be used alone or two sorts or more may be used in combination.

As the nonaqueous solvent, propylene carbonate (PC), ethylene carbonate (EC), and a cyclic carbonate such as vinylene carbonate, chain carbonate such as diethyl carbonate (DEC), dimethyl carbonate (DMC) and methyl ethyl carbonate (MEC), cyclic ethers such as tetrahydrofuran (THF), 2-methyltetrahydrofuran (2MeTHF) and dioxolane (DOX), chain ether such as dimethoxyethane (DME) and diethoethane (DEE), γ-butyrolactone (GBL), acetonitrile (AN) and sulfolane (SL) may be used alone or in combination.

Preferably, a mixed solvent in which two or more sorts of a group consisting of propylene carbonate (PC), ethylene carbonate (EC) and γ-butyrolactone (GBL) are mixed is used. More preferably, a mixed solvent in which γ-butyrolactone (GBL) is mixed with other solvents is used. The reason therefor is as follows.

Firstly, γ-butyrolactone, propylene carbonate and ethylene carbonate have high boiling points and flash points and are excellent in thermal stability.

Secondly, γ-butyrolactone is reduced more easily than the chain carbonate and the cyclic carbonate, and specifically, easiness of being reduced is decreased in the order of:

γ-butyrolactone>>>ethylene carbonate>propylene carbonate>>dimethyl carbonate>methyl ethyl carbonate>diethyl carbonate, in which the more the number “>” is, the larger the difference in reactivity between solvents is.

γ-butyrolactone is slightly reduced and decomposed in an operating potential region of the Li titanium composite oxide in the nonaqueous electrolyte. This decomposed product further forms a stable film on the surface of a Li titanium oxide in cooperation with an amino compound. This also applies to the aforementioned mixed solvents. Accordingly, the solvents that are reduced more easily are used more suitably.

In order to form a high quality film on the negative electrode surface, the content of γ-butyrolactone is preferably from 40% by volume to 95% by volume.

Although the nonaqueous electrolyte containing γ-butyrolactone exhibits the aforementioned excellent effects, it has a high viscosity and a low impregnation property in an electrode. However, if using negative electrode active materials having an average particle size of 1 μm or less, even the nonaqueous electrolyte containing γ-butyrolactone may be impregnated smoothly. Accordingly, this may enhance the productivity and enhance the output characteristics and charge-discharge cycle characteristics.

3) The Positive Electrode

The positive electrode may contain a positive electrode current collector and a positive electrode active material containing layer supported on one side or both sides of the positive electrode current collector. A positive electrode active material containing layer may contain the positive electrode active material and may arbitrarily contain a positive electrode conducting agent and a binder.

As the positive electrode active material, for example, oxides, sulfides and polymer may be used.

Examples of the oxides that Li or Li ion being inserted to include manganese dioxide (MnO₂), iron oxide, copper oxide, nickel oxide, and Li manganese composite oxides (for example, LiₓMn₂O₄ or LiₓMnO₂), Li nickel composite oxide (for example, LiₓNiO₂), Li cobalt composite oxide (LiₓCoO₂), Li nickel cobalt composite oxide (for example, LiNi_{1-y}Co_{y}O₂), Li manganese cobalt composite oxides (for example, LiMn_{y}Co_{1-y}O₂), spinel type Li-manganese-nickel composite oxide (LiₓMn_{2-y}Ni_{y}O₄), Li phosphate oxide having an olivine structure (LiₓFePO₄, LiₓFe_{1-y}Mn_{y}PO₄, and LiₓCoPO₄ etc.), iron sulfate (Fe₂(SO₄)₃), vanadium oxide (for example, V₂O₅) and Li-nickel-cobalt-manganese composite oxide, in which x and y are preferably within 0 to 1.2.

Examples of the polymers include conductive polymer materials such as polyaniline or polypyrrole, or disulfide polymer materials. Additionally, sulfur (S) and carbon fluoride may be used.

Examples of positive electrode active materials which provide a high positive electrode potential include Li manganese composite oxides (LiₓMn₂O₄), Li nickel composite oxide (LiₓNiO₂), Li cobalt composite oxide (LiₓCoO₂), Li nickel cobalt composite oxide (LiₓNi_{1-y}Co_{y}O₂), spinel type Li-manganese-nickel composite oxide (LiₓMn_{2-y}Ni_{y}O₄), Li manganese cobalt composite oxide (LiₓMn_{y}CO_{1-y}O₂), Li iron phosphate (LiₓFePO₄) and Li-nickel-cobalt-manganese composite oxide, in which x and y are preferably 0 to 1.2.

The composition of the aforementioned Li-nickel-cobalt-manganese composite oxide is preferably LiₐNi_{b}Co_{c}Mn_{d}O2 (in which the molar ratio of a, b, c and d is 0≦a≦1.2, 0.1≦b≦0.9, 0≦c≦0.9, 0.1≦d≦0.5).

As the positive electrode active material, if using Li-transition metal composite oxides such as LiCoO₂ and LiMn₂O₄, an isocyanate compound is oxidatively decomposed slightly and may contaminate the positive electrode surface. In this case, a partial or entire surface of particles of the Li-transition metal composite oxides is preferably covered with an oxide of at least one element of Al, Mg, Zr, B, Ti and Ga. This may suppress the oxidization decomposition of the nonaqueous electrolyte on the positive electrode active material surface even if the nonaqueous electrolyte may contain an isocyanate compound. Accordingly, the contamination on the positive electrode surface may be reduced and a longer-lived nonaqueous electrolyte battery may be obtained.

As oxides used for covering, for example, Al₂O₃, MgO, ZrO₂, B₂O₃, TiO₂ or Ga₂O₃ may be used. Preferably, 0.1 mass % to 15 mass %, and more preferably, 0.3 mass % to 5 mass % of the oxides are contained to the amount of the Li-transition metal composite oxides but not limited thereto. Employing 0.1 mass % or more of the oxides used for covering may suppress the oxidization decomposition of the nonaqueous electrolyte on the surface of the Li-transition metal composite oxides. Employing 15 mass % or less of oxides may realize high capacity Li-ion batteries.

Further, Li transition metal composite oxide particles to which oxides used for covering as described above are attached and Li transition metal composite oxide particles to which these oxides are not attached may be contained in the Li transition metal composite oxides.

The oxides used for covering are preferably MgO, ZrO₂ or B₂O₃. Using the Li transition metal composite oxide particles to which these oxides are attached as the positive electrode active material of the Li-ion battery may further raise a charging voltage to (for example, 4.4 V or more), and may improve the charge-discharge cycle characteristics.

The composition of the Li transition metal composite oxides may contain other unavoidable impurities.

The Li transition metal composite oxides may be covered as follows. Firstly, an aqueous solution containing an ion of at least one element M of Al, Mg, Zr, B, Ti and Ga is impregnated in particles of the Li transition metal composite oxides. The obtained impregnation Li transition metal composite oxide is fired to obtain the Li transition metal composite oxide particles covered with oxides of the element M of at least one element M of Al, Mg, Zr, B, Ti and Ga.

The forms of the aqueous solution used for impregnation are not particularly limited but are required to allow an oxide of at least one element M of Al, Mg, Zr, B, Ti and Ga to attach to the surface of the Li transition metal composite oxide after firing, and an aqueous solution containing Al, Mg, Zr, B, Ti and Ga in the suitable form may be used. The forms of these metals (including boron) may be, for example, oxy nitrate salt, nitrate salt, acetate, sulfate, carbonate, hydroxide or acid etc. of at least one element selected from Al, Mg, Zr, B, Ti and Ga.

As described above, the oxides used for covering are preferably MgO, ZrO₂ or B₂O₃ and thus the ions of the elements M are more preferably Mg ion, Zr ion or B ion. As the aqueous solution containing the ion of the element M, for example, Mg(NO₃)₂ aqueous solution, ZrO(NO₃)₂ aqueous, ZrCO₄.ZrO₂.8H₂O aqueous solution, Zr(SO₄)₂ aqueous solution or H₃BO₃ aqueous solution are more preferable, and of these, Mg(NO₃)₂ aqueous solution, ZrO(NO₃)₂ aqueous, or H₃BO₃ aqueous are the most preferable.

The concentration of an ionic aqueous solution of the element M is not particularly limited but a saturated aqueous solution is preferable. Using the saturated aqueous solution may make the volume of a solution smaller during the impregnation process.

The forms of an ion of the element M in the aqueous solvent may be not only an ion made of M element alone but also the state of an ion combined with other elements. Taking boron as an example, it may be, for example, B(OH)⁴⁻.

The mass ratio of the Li-transition metal composite oxide and the ionic aqueous solution of the element M during the impregnation process is not particularly limited but may be the mass ratio depending upon the composition of the Li-transition metal composite oxide to be produced. The time for conducting enough impregnation is sufficient for the impregnation time, and the impregnation temperature is not particularly limited.

The temperature and time of firing may be determined as necessary, and preferably 1 to 5 hours at 400 to 800 degrees Celsius, more preferably 3 hours at 600 degrees. Further, the firing may be conducted under an oxygen stream or in the atmosphere. The particles after impregnation may be fired without modification but the particles are preferably dried before firing in order to remove moisture content in the mixture. In this case, drying may be conducted by means of commonly known methods, such as heating in an oven or hot air drying etc. alone or in combination. Further, the drying is preferably conducted under the oxygen or air atmosphere etc.

The covered Li-transition metal composite oxides that are thus obtained may be pulverized as necessary.

The primary particle size of the positive electrode active material is preferably from 100 nm to 1 μm. The positive electrode active material of 100 nm or more may be easily handled when industrially produced. 1 μm or less thereof may proceed with the diffusion of Li ions in solid smoothly.

The specific surface area of the positive electrode active material is preferably from 0.1 m²/g to 10 m²/g. 0.1 m²/g or more thereof may sufficiently secure a site that Li ions inserted to and/or extracted from. 10 m²/g or less thereof may be easily handled when industrially produced and secure good charge-discharge cycle characteristics.

As the positive electrode conducting agent which increases the current collecting performance and suppress the contact resistance with the current collector, for example, carbonaceous matters such as acetylene black, carbon black and graphite may be used.

As the binder which bind the positive electrode active material and positive electrode conducting agent, for example, the polytetrafluoroethylene (PTFE), polyvinylidene fluoride (PVdF), and fluororubbers may be used.

As for the compounding ratio of the positive electrode active material, the positive electrode conducting agent and the binder, the positive electrode active material is preferably from 80 mass % to 95 mass %, the positive electrode conducting agent is preferably from 3 mass % to 18 mass % and the binder is preferably from 2 mass % to 17 mass %. Employing the positive electrode conducting agent of 3 mass % or more may produce the aforementioned effects and employing 18 mass % or less of thereof may reduce the decomposition of the nonaqueous electrolyte on the positive electrode conducting agent under hot holding. Employing the binder of 2 mass % or more may provide sufficient electrode strength and employing 17 mass percent or less thereof may reduce the compounding amount of an insulator of an electrode and may reduce an internal resistance.

The positive electrode current collector is preferably an aluminum foil or an aluminum alloy foil. Similarly to the negative electrode collector, the average crystalline grain size is preferably 50 μm or less, and more preferably 30 μm or less, and even more preferably 5 μm or less. The average crystalline grain size of 50 μm or less may dramatically increase the strength of the aluminum foil or the aluminum alloy foil, which makes it possible that the positive electrode is densified at a high pressing pressure, and may increase the battery capacity.

The thickness of the aluminum foil or the aluminum alloy foil is 20 μm or less, and more preferably 15 μm or less. The purity of the aluminum foil is preferably 99 mass % or more. As the aluminum alloy, an alloy containing elements such as magnesium, zinc, or silicon is preferable. On the other hand, the content of the transition metals such as iron, copper, nickel, chrome is preferably 1 mass % or less.

The positive electrode may be produced by, for example, applying slurry prepared by suspending the positive electrode active material, positive electrode conducting agent and binder in a suitable solvent to the positive electrode current collector, drying it, forming a positive electrode active material-containing layer and then subjecting it to the press. Otherwise, the positive electrode active material, positive electrode conducting agent and binder are formed into a pellet shape, which may be used as the positive electrode active material-containing agent.

4) A Separator

As the separator, a porous film containing, for example, polyethylene, polypropylene, cellulose or polyvinylidene fluoride (PVdF), or nonwoven fabric of synthetic resin may be used. As the cellulose has a hydroxyl group at its end, it easily introduces moisture into cells. Accordingly, using the separator containing especially cellulose exerts the effect of this Embodiment.

The separator preferably has a median pore size of 0.15 μm to 2.0 μm which is measured by a mercury porosimetry. Employing 0.15 μm or more of the median pore size may make a film resistance of the separator smaller and produce the high power. Alternatively, employing 2.0 μm or less thereof causes the shutdown of the separator evenly to realize a high safety. Otherwise, diffusion of the nonaqueous electrolyte due to the capillary phenomenon is advanced, and consequently the cycle deterioration due to exhaustion of the nonaqueous electrolyte is prevented. The more preferable range is from 0.18 μm to 0.40 μm.

The separator preferably has a mode pore size of 0.12 μm to 1.0 μm which is measured by a mercury porosimetry. Employing 0.12 μm or more of the mode pore size may make a film resistance of the separator smaller and produce the high power, and prevents change of properties of the separator at a high temperature and in a high voltage environment, and produce the high power. Alternatively, employing 1.0 μm or less thereof causes the shutdown of the separator evenly to realize a high safety. The more preferable range is from 0.18 μm to 0.35 μm.

The porosity of the separator is preferably 45% to 75%. Employing the porosity of 45% produces a sufficient absolute amount of ions in the separator and the high power. Employing the porosity of 75% or less makes the strength of the separator higher and causes the uniform shutdown, thus realizing a high safety. The more preferable range is from 50% to 65%.

5) Container Member

As a container member, for example, a laminated film with the thickness of 0.2 mm or less or a metal container with the thickness of 1.0 mm or less may be used. The thickness of the metal container is preferably 0.5 mm or less.

The shape may be flat-type, square-type, tubular-type, coin-type, button-type, sheet-type or laminated-type depending upon the usage of the nonaqueous electrolyte battery according to Embodiment 1. The usage of the nonaqueous electrolyte battery according to Embodiment 1 is, for example, a small-size battery loaded on portable electronics etc. or a large-size battery loaded on two to four wheeled vehicles etc.

The laminated film is a multilayer film made of a metal layer and a resin layer covering the metal layer. In order to trim weight, the metal layer is preferably an aluminum foil or an aluminum alloy foil. The resin layer strengthens the metal layer, for which polymers such as polypropylene (PP), polyethylene (PE), nylon and polyethylene terephthalate (PET) may be used. The laminated film is molded by performing sealing by thermal fusion.

The metal container may be made of aluminum or aluminum alloy. The aluminum alloy is preferably an alloy containing elements such as magnesium, zinc and silicon. On the other hand, the content of transition metals such as iron, copper, nickel and chrome is preferably 1 mass % or less. This may dramatically enhance long-term reliability, radiation performance in the high-temperature environment.

The average crystalline grain size of the metal can made of aluminum or aluminum alloy is preferably 50 μm or less, and more preferably 30 μm or less, and even more preferably 5 μm or less. Employing the average crystalline grain size of 50 μm or less may dramatically increase the strength of the metal can made of aluminum or aluminum alloy, and makes the can thinner. As a result, a lightweight and high-powered battery excellent in long-term reliability which is suitable for vehicle installation may be provided.

6) A Negative Electrode Terminal

A negative electrode terminal may be formed from materials having the electrical stability and conductivity at a potential to Li ion metals from 0.4 V to 3 V. Specifically, the aluminum alloy or aluminum containing elements such as Mg, Ti, Zn, Mn, Fe, Cu and Si may be listed. The material similar to the negative electrode current collector is preferable in order to reduce the contact resistance.

7) A Positive Electrode Terminal

A positive electrode terminal may be formed from materials having the electrical stability and conductivity at a potential to Li ion metals from 3 V to 5 V. Specifically, the aluminum alloy or aluminum containing elements such as Mg, Ti, Zn, Mn, Fe, Cu and Si may be listed. The material similar to the positive electrode current collector is preferable in order to reduce the contact resistance.

Next, with reference to drawings, some examples of the nonaqueous electrolyte batteries of Embodiment 1 will be explained.

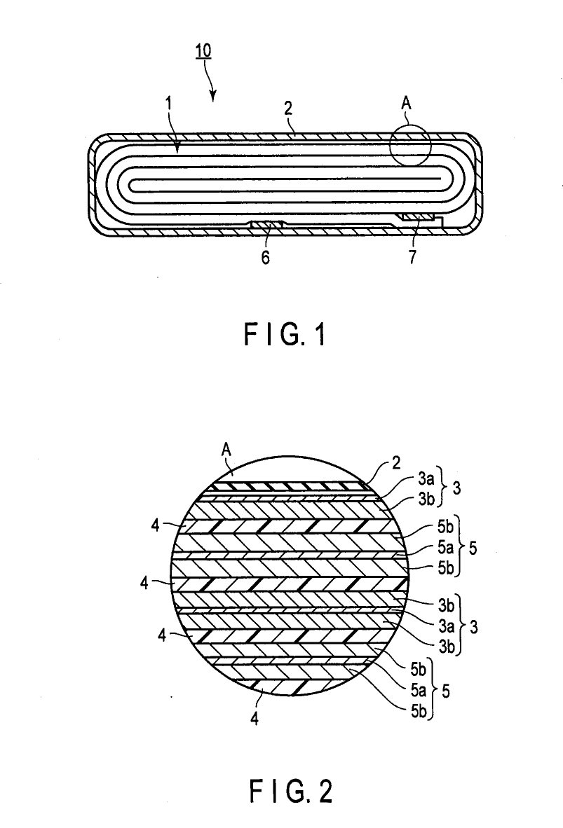

Firstly, with reference to FIG. 1 and FIG. 2, a flat-type nonaqueous electrolyte battery as one example of the nonaqueous electrolyte battery of Embodiment 1 will be explained.

FIG. 1 shows a sectional schematic view of a flat-type nonaqueous electrolyte battery as one example of Embodiment 1. FIG. 2 shows an enlarged sectional view of Part A in FIG. 1.

The nonaqueous electrolyte battery 10 shown in FIG. 1 and FIG. 2 includes a winding type flat electrode group 1.

The flat would electrode group 1 includes a negative electrode 3, a separator 4 and a positive electrode 5 as shown in FIG. 2. The separator 4 is interposed between the negative electrode 3 and the positive electrode 5. Such flat would electrode group 1 may be formed by winding the laminated material formed by laminating the negative electrode 3, the separator 4 and the positive electrode 5 such that the separator 4 intetposes between the negative electrode 3 and the positive electrode 5 with the negative electrode 3 out in spiral form and pressing it into shapes as shown in FIG. 2.

The negative electrode 3 includes a negative electrode current collector 3a and a negative electrode layer 3b. The negative electrode 3 as the outermost shell is configured such that the negative electrode layer 3b is formed only on one surface on the inner surface side of the negative electrode current collector 3a as shown in FIG. 2. Other negative electrodes 3 are configured such that the negative electrode layer 3b is formed on both sides of the negative electrode current collector 3a.

The positive electrode 5 is configured such that a positive electrode layer 5b is formed on both sides of a positive electrode current collector 5a.

As shown in FIG. 2, in the vicinity of the outer circumferential end of the winding type electrode group 1, a negative electrode terminal 6 is connected to the negative electrode current collector 3a of the negative electrode 3 of the outermost shell, and a positive electrode terminal 7 is connected to the positive electrode current collector 5a of the positive electrode 5 on the inner side.

The winding type electrode group 1 is stored in a bag-like container 2 made of a laminated film in which a metal layer interposes between two resin layers.

The negative electrode terminal 6 and positive electrode terminal 7 extend outward from an opening of the bag-like container 2. For example, a liquid nonaqueous electrolyte is infused from the opening of the bag-like container 2 and stored in the bag-like container 2.

The opening of the bag-like container 2 between the negative electrode terminal 6 and the positive electrode terminal 7 is heat-sealed, which totally seals the winding type electrode group 1 and the liquid nonaqueous electrolyte.

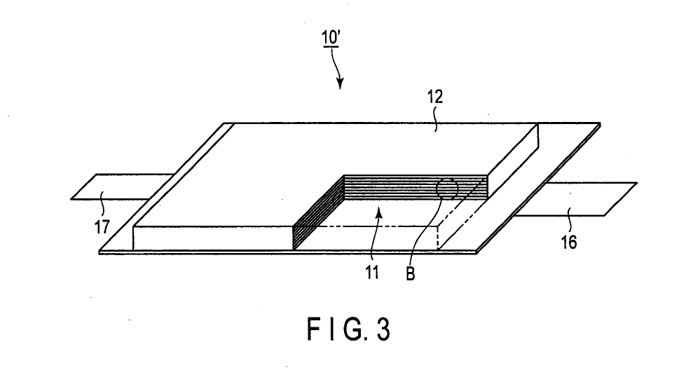

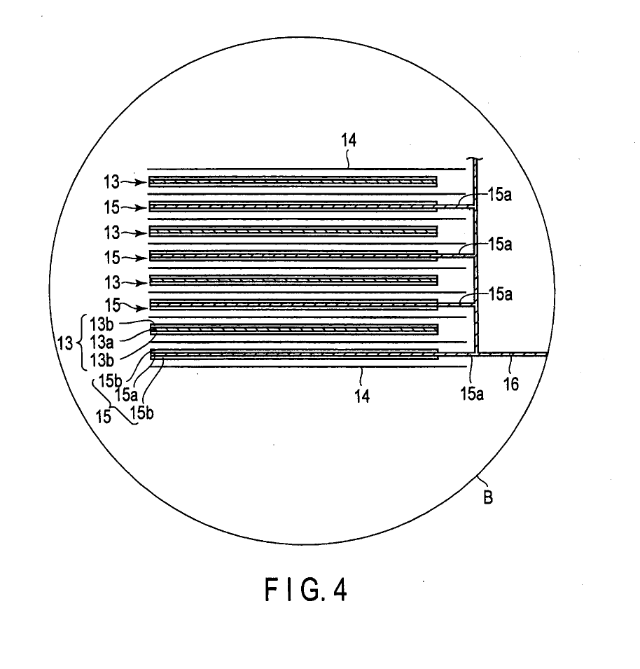

Subsequently, with reference to FIG. 3 and FIG. 4, nonaqueous electrolyte battery as an alternative example of the nonaqueous electrolyte battery according to Embodiment 1 will be explained.

FIG. 3 shows a schematic partially notched perspective view of a nonaqueous electrolyte battery as other example according to Embodiment 1. FIG. 4 shows a sectional schematic view of Part B in FIG. 3.

A battery 10′ shown in FIG. 3 and FIG. 4 includes a lamination type electrode group 11.

The lamination type electrode group 11 is stored in a container 12 made of a laminated film in which a metal layer interposes between two resin films. The lamination type electrode group 11 is configured by alternately laminating a positive electrode 13 and a negative electrode 15 between which a separator 14 interposes as shown in FIG. 4. There are a plurality of pieces of the positive electrodes 13, each of which includes a current collector 13a and a positive electrode active material-containing layer 13b supported on both sides of the current collector 13a. There is a plurality of pieces of the negative electrodes 15, each of which includes a negative electrode current collector 15a and a negative electrode active material-containing layer 15b supported on both sides of the negative electrode current collector 15a. One side of a negative electrode current collector 15a of each negative electrode 15 protrudes from the negative electrode 15. The protruding negative electrode current collector 15a is electrically connected to a belt-shaped negative electrode terminal 16 as shown in FIG. 4. The tip of the negative electrode terminal 16 is drawn outward from the container 12. Further although now shown, of the positive electrode current collector 13a of the positive electrode 13 protrudes from the positive electrode, a side located on opposite side of a protruding side of the negative electrode current collector 15a protrudes from the positive electrode 13. The positive electrode 13a protruding from the positive electrode 13 is electrically connected to a band-shaped positive electrode terminal 17. The tip of the band-shaped positive electrode terminal 17 is located on opposite side of the negative electrode terminal 16 and is drawn outward from a side of the container 12.

According to Embodiment 1, the nonaqueous electrolyte battery is provided. Thanks to the negative electrode active material having a Li insertion/extraction potential of 0.4 V (vs. Li/Li⁺) or more and the nonaqueous electrolyte containing the silicon compound containing the isocyanate group and the isothiocyanate group, the nonaqueous electrolyte battery may suppress the decomposition of the nonaqueous electrolyte on the negative electrode surface if exposed in a high-temperature state and the accompanying heat generation.

### Embodiment 2

According to Embodiment 2, a battery pack is provided. This battery pack includes the nonaqueous electrolyte battery according to Embodiment 1.

The battery pack according to Embodiment 2 may include one nonaqueous electrolyte battery or a plurality of nonaqueous electrolyte batteries. Alternatively, if the battery pack according to Embodiment 2 includes a plurality of nonaqueous electrolyte batteries, unit cells may be electrically connected in series or in parallel or may be connected in series and parallel in combination to be disposed.

Subsequently, one example of the battery pack according to Embodiment 2 will be explained with reference to the figures.

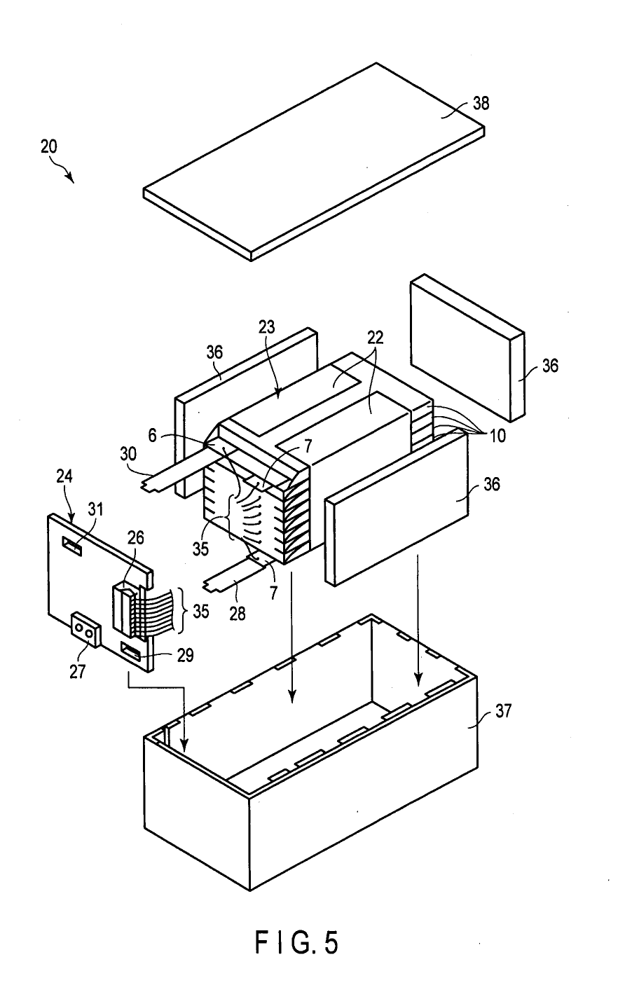

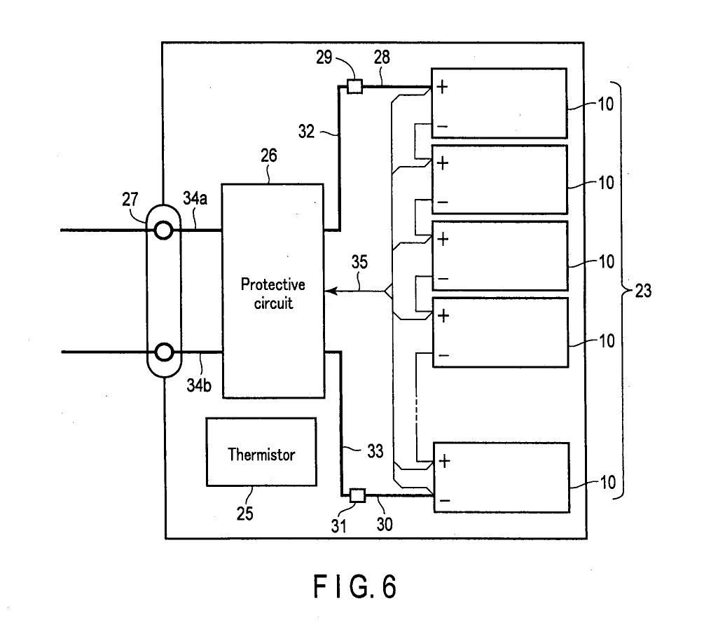

FIG. 5 shows an exploded perspective view of a battery pack as one example of Embodiment 2. FIG. 6 shows a block diagram illustrating an electric circuit of a battery pack shown in FIG. 5.

The battery pack 20 shown in FIG. 5 and FIG. 6 contains a plurality of flat type batteries 10 having a structure shown in FIG. 1 and FIG. 2.

A plurality of unit cells 10 are laminated such that the negative electrode terminal 6 and the positive electrode terminal 7 which extend outward are arranged in the same direction, and fastened by an adhesive tape 22, which configure an assembled battery 23. These unit cells 10 are electrically connected with each other in series as shown in FIG. 6.

A printed circuit board 24 is disposed oppositely to a side face from which the negative electrode terminal 6 and the positive electrode terminal 7 of the plurality of unit cells 10 extend. On the printed circuit board 24, a thermistor 25, a protective circuit 26 and a terminal 27 for powering an external device shown in FIG. 6 are mounted. On the surface opposing to the assembled battery 23 of the printed circuit board 24, an insulating plate (not shown) for avoiding unnecessary connection with a battery wiring of the assembled battery 23 is installed.

A positive electrode lead 28 is connected to the positive electrode terminal 7 of the unit cell 10 located on the lowest layer of the assembled battery 23, and its tip is connected to a positive electrode connector 29 of the printed circuit board 24 and its tip is inserted in a positive electrode connector 29 of the printed circuit board 24 and electrically connected thereto. A negative electrode lead 30 is connected to the negative electrode terminal 6 of the unit cells 10 located on the top layer of the assembled battery 23 and its tip is inserted in a negative electrode connector 31 of the printed circuit board 24 and electrically connected thereto. These connectors 29, 31 are connected to the protective circuit 26 through wiring 32 and 33 formed on the printed circuit board 24, respectively.

The thermistor 25 detects temperature of each unit cell 10 and transmits the detection signal to the protective circuit 26. The protective circuit 26 may interpret a plus side wiring 34a and a minus side terminal 34b between the protective circuit 26 and a terminal 27 for energizing an external device under the predetermined conditions. The predetermined condition is, for example, when the temperature detected by the thermistor 25 is equal to a predetermined temperature or higher. Another example of the predetermined condition is when an over-charge, an over-discharge, an over-current or the like of the unit cell 10 is detected. The over-charge, the over-discharge, the over-current or the like is detected for each of the unit cells 10 or for whole the unit cell 10. If detecting the individual unit cell 10, a cell potential may be detected or a positive electrode potential or a negative electrode potential may be detected. In the latter case, a Li electrode used as a reference electrode is inserted in the individual unit cell 10. In a battery pack in FIG. 5 and FIG. 6, the wirings 35 for detecting the voltage are connected to the respective unit cells 10 and the detection signals are transmitted to the protective circuit 26 through these wirings 35.

On each of three side faces of the assembled battery 23 excluding a side surface from which the positive electrode terminal 7 and the negative electrode terminal 6 protrude, a protective sheet 36 made of rubber or resin is disposed.

The assembled battery 23 is stored in a storage container 37 together with each protective sheet 36 and printed circuit board 24. Namely, on the respective both inner side surfaces of the long side direction and the inner side surface of the short side direction of the storage container 37, the protective sheet 36 are disposed, and the printed circuit board 24 is disposed on the inner side surface on the opposite side of the short side direction. The assembled battery 23 is positioned in a space surrounded by the protection sheets 36 and the printed circuit board 24. A cover 38 is attached on the upper surface of the storage container 37.

Instead of the adhesive tape 22, a heat shrinkage tape may be used for fixing the assembled battery 23. In this case, the protective sheets are disposed on both sides of the assembled battery and the heat shrinkage tape is allowed to go around and then the heat shrinkage tape is heat-shrunk to bundle the assembled battery.

The battery pack 20 shown in FIG. 5 and FIG. 6 is formed such that a plurality of unit cells 10 are connected in series but the battery pack according to Embodiment 2 may be formed such that the plurality of unit cells 10 are connected in parallel in order to increase the battery capacity. Alternatively, the battery pack according to Embodiment 2 may include the plurality of unit cells 10 connected in series and parallel in combination. The assembled battery packs 20 may be further connected in series or parallel.

The battery pack 20 shown in FIG. 5 and FIG. 6 includes the plurality of unit cells 10 but the battery pack according to Embodiment 2 may include one unit cell 10.

An embodiment of the battery pack may be modified as necessary depending upon its usage. The battery pack according to this embodiment is suitably used for the purpose requiring excellent cycle characteristics when taking the large current, and specifically used as a power source of a digital camera or for example, on-vehicle batteries of two to four wheeled hybrid electric vehicles, two wheeled to four wheeled electric vehicles and assist bicycles, and especially used as on-vehicle batteries suitably.

The battery pack according to Embodiment 2 includes the nonaqueous electrolyte battery of Embodiment 1 and may thus suppress the heat generation of the negative electrode of this nonaqueous electrolyte battery and may consequently exhibit a high safety.

### EXAMPLES

Although examples will be explained below, the present invention is not limited the examples described below without deviating from the gist of the present invention.

### Example 1-1

In Example 1-1, a beaker cell was produced according to the following procedures.

### <Preparation of the Negative Electrode>

As the negative electrode active material, titanium oxide (TiO₂) powders having a monoclinic β type structure were prepared. These particles were agglomerated particles made of fiber particles having a fiber diameter of 0.2 μm and a fiber length of 1 μm and having an average particle size of 15 μm, and having the BET specific surface area of 15 m²/g, and Li insertion potential of 1.5 V (vs. Li/Li⁺). The particle size of the negative electrode active material was measured by using Laser Diffraction Particle Size Analyzer (SHIMADZU SALD-300) as follows. Firstly, samples of about 0.1 g, a surfactant and distilled water of 1 to 2 mL were added in a beaker to stir them fully, which were infused in a water stirring tank to measure the luminous intensity distribution 64 times at intervals of 2 seconds. The particle size is determined by analyzing the obtained particle size distribution data.

The titanium oxide powders of 90 mass, acetylene black of 5 mass % as a conducting agent and polyvinylidene fluoride (PVdF) of 5 mass % as a binder were infused in N-methylpyrrolidone (NMP) such that the solid content ratio is 62%. The obtained mixture was kneaded by a planetary mixer, and NMP was further added thereto to gradually decrease the solid content ratio to prepare slurry having a viscosity of 10.2 cp (a B type viscometer, a value at 50 rpm). This slurry was further mixed by a beans mill using a zirconia bowl having a diameter of 1 mm as media.

The obtained slurry was applied to one side of a current collector made of an aluminum foil with the thickness of 15 μm (purity of 99.3 mass %, an average crystalline grain size of 10 μm), which was dried and then roll-pressed by a roll heated up to 100 degrees Celsius to obtain an electrode.

### <Preparation of Liquid Nonaqueous Electrolyte>

Ethylene carbonate (EC) and diethyl carbonate (DEC) was mixed at a volume ratio of 1:2 to form a mixed solvent. LiPF₆ which is an electrolyte was dissolved in this mixed solvent at a concentration of 1 M and trimethylsilyl isocyanate of 1.0 mass % was added thereto and then mixed to obtain a nonaqueous electrolyte which is a liquid at 20 degrees Celsius and 1 atom.

### <Preparation of a Beaker Cell>

A beaker cell using the produced electrode as a working cell and using Li metal as a counter electrode and a reference electrode was produced and the aforementioned liquid nonaqueous electrolyte was infused therein to complete the beaker cell in Example 1-1.

### Comparative Example 1-1

Trimethylsilyl isocyanate of 1.0 mass % was not added to a non-electrolyte, and other procedures were the same as those in Example 1-1 to produce a beaker cell in Comparative Example 1-1.

### Examples 1-2 to 1-6 and Comparative Examples 1-2 and 1-3

Instead of trimethylsilyl isocyanate, additives described in Table 1 were added to a nonaqueous electrolyte, and other procedures were the same as those in Example 1-1 to produce a respective beaker cell in Examples 1-2 to 1-6 and Comparative Examples 1-2 and 1-3.

### Examples 1-7 to 1-11

The additive amount of trimethylsilyl isocyanate was modified as shown in Table 1, and other procedures were the same as those in Example 1-1 to produce a respective beaker cell in Examples 1-7 to 1-11.

### Example 1-12 and Comparative Example 1-4

Antimony powders having a particle size of about 20 μm were used as a negative electrode active material, and other procedures were the same as the respective procedures in Example 1-1 and Comparative Example 1-4 to produce a respective beaker cell in Example 1-12 and Comparative Example 1-4.

### Comparative Examples 1-5 and 1-6

Graphite having a particle size of 6 μm was used as a negative electrode active material, and a copper foil with the thickness of 12 μm was used for a current collector, and other procedures were the same as the respective procedures in Example 1-1 and Comparative Example 1-1 to produce a respective beaker cell in Comparative Example 1-5 and Comparative Example 1-6.

### Comparative Example 1-7

Instead of trimethylsilyl isocyanate of 1.0 mass, trimethylsilylphosphate of 1.0 mass % and diisocyanatehexane of 1.0 mass % were added to a nonaqueous electrolyte, and other procedures were the same as those in Example 1-1 to produce a beaker cell in Comparative Example 1-7.

### <Test>

The Li had been inserted in the beaker cells in Examples 1-1 to 1-12 and Comparative Examples 1-1 to 1-7 at constant current and constant voltage of 0.2 C-1 V (vs. Li/Li⁺) for 10 hours and the Li was then extracted at a constant current of 0.2 C up to a potential of 3 V (vs. Li/Li⁺) and subsequently the Li had been inserted for at constant current and constant voltage of 1 C-1 V (vs. Li/Li⁺) for 3 hours.

The constant potential voltage when the Li or Li ion being inserted to in the beaker cells in Example 1-12 and Comparative Example 1-4 using the antimony powders as the negative electrode material was set to 0.5 V (vs. Li/Li⁺). The constant potential voltage when the Li or Li ion being inserted to in the beaker cells in Comparative Examples 1-5 and 1-6 using the graphite was set to 0.1 V (vs. Li/Li⁺). The Li insertion/extraction potential was 1.5 V (vs. Li/Li⁺) for the titanium oxide and 0.8 V (vs. Li/Li⁺) for the antinomy and 0.1 V (vs. Li/Li⁺) for the graphite.

Subsequently, a cell resistance was measured by an alternating current impedance method and then the beaker cell in this state was disassembled in an inert atmosphere and an electrode layer was stripped. The stripped electrode layer was dried and weighted, and encapsulated in a stainless pressure-proof container (volume: 70 μL, withstand pressure of 5 MPa) for differential scanning calorimetry (DSC) together with a nonaqueous electrolyte obtained by dissolving at a concentration of 1 M an electrolyte, LiPF₆ in a mixed solvent in which the nonaqueous electrolyte (ethylene carbonate (EC) and diethyl carbonate (DEC) of the same mass of that of the electrode layer was mixed at a volume ratio of 1:2) and the DSC measurement was performed to obtain a heating value under the following conditions when heated up to 200 degrees Celsius. A ratio of a cell resistance to the heating value and Comparative Example 1 is shown in Table 1.
measured temperature range: 25 to 500 degrees Celsius rate of temperature increase: 5 degrees Celsius/minute measuring atmosphere: He (purity: 99.9999%, 100 ml/minute)

TABLE 1

| | | Additive | Heating | Re- |
|---|---|---|---|---|
| | | amount | value | sistance |
| | Additive | [mass %] | [J/g] | ratio |
| Example 1-1 | trimethylsilyl isocyanate | 1.0 | 68 | 0.8 |
| Comparative | none | — | 268 | 1.0 |
| Example 1-1 | | | | |
| Example 1-2 | trimethylsilyl | 1.0 | 78 | 0.9 |
| | isothiocyanate | | | |
| Example 1-3 | (trimethylsilyl)methyl | 1.0 | 80 | 1.0 |
| | isocyanate | | | |
| Example 1-4 | (trimethylsilyl)methyl | 1.0 | 84 | 1.0 |
| | isothiocyanate | | | |
| Example 1-5 | dimethyl silyl isocyanate | 1.0 | 132 | 1.1 |
| Example 1-6 | methyl silyl triisocyanate | 1.0 | 124 | 1.1 |
| Comparative | trimethyl silyl phosphate | 1.0 | 270 | 0.8 |
| Example 1-2 | | | | |
| Comparative | diisocyanate hexane | 1.0 | 301 | 1.8 |
| Example 1-3 | | | | |
| Example 1-7 | trimethylsilyl isocyanate | 0.01 | 198 | 0.9 |
| Example 1-8 | trimethylsilyl isocyanate | 0.1 | 128 | 0.8 |
| Example 1-9 | trimethylsilyl isocyanate | 0.5 | 84 | 0.8 |
| Example 1-10 | trimethylsilyl isocyanate | 3 | 121 | 1.0 |
| Example 1-11 | trimethylsilyl isocyanate | 5 | 189 | 1.4 |
| Comparative | none | — | 302 | 2.0 |
| Example 1-4 | | | | |
| Example 1-12 | trimethylsilyl isocyanate | 1.0 | 242 | 2.0 |
| Comparative | none | — | 1080 | 3.9 |
| Example 1-5 | | | | |
| Comparative | trimethylsilyl isocyanate | 1.0 | 1120 | 4.3 |
| Example 1-6 | | | | |
| Comparative | trimethyl silyl phosphate | 1.0 | 298 | 1.4 |
| Example 1-7 | and diisocyanate hexane | respectively | | |
| | used in combination | | | |

It is seen from the results shown in Table 1 that the battery using the titanium oxide as the negative electrode active material could suppress the heating value when heated up to 200 degrees Celsius in Examples 1-1 to 1-11 in which the silicon compound having the isocyanate group or the isothiocyanate group was added to the nonaqueous electrolyte than in Comparative Examples 1-1 to 1-3 and Comparative Example 1-7 in which the silicon compound was not added. It is further seen that in Examples 1-1 to 1-4 in which the silicon compound further containing a trimethylsilyl group was added to the nonaqueous electrolyte, the heating value was even smaller than that in Examples 1-5 and 1-6 in which the silicon compound having the isocyanate group or the isothiocyanate group was added to the nonaqueous electrolyte in the same additive amount.

Comparing results of Examples 1-1 and Examples 1-7 to 1-11 with results of Comparative Example 1-1, it is seen that even if the additive amount of the silicon compound having the isocyanate group or the isothiocyanate group was modified, the heat generation could be similarly suppressed.

In Comparative Example 1-2 in which a compound having the trimethylsilyl group was added alone, Comparative Example 1-3 in which a compound having the isocyanate group was added alone and Comparative Example 1-7 in which both a compound having the trimethylsilyl group and a compound having the isocyanate group were added, it is seen that a higher heating value was measured than in Example 1-1 and Examples 1-7 to 1-11 in which the silicon compound having the isocyanate group or the isothiocyanate group was added to the nonaqueous electrolyte. It is seen that especially in Examples 1-1 to 1-4 and Examples 1-7 to 1-11 in which the silicon compound having the isocyanate group or the isothiocyanate group and the trimethylsilyl group were added to the nonaqueous electrolyte, the heating value was suppressed much more than the aforementioned Comparative Examples 1-2, 1-3 and 1-7.

It is seen from the results of Example 1-12 and Comparative Example 1-4 that also in case where the antimony powders having a Li insertion/extraction potential of 0.8 V (vs. Li/Li⁺) was used as the negative electrode active material, similar results to those in case where the titanium oxide was used as the negative electrode active material were obtained.

On the other hand, it is seen from the results of Comparative Example 5 and Comparative Example 6 that in case where the graphite having a Li insertion/extraction potential of 0.1 V (vs. Li/Li⁺) was used as the negative electrode active material, even if the silicon compound having the isocyanate group or the isothiocyanate group was added to the nonaqueous electrolyte, the effects of suppressing the heat generation could not obtained.

### Examples 2-1 to 2-6 and Comparative Example 2-1

Titanium composite oxide (Li₄Ti₅O₁₂) powders having a spinel structure were used as a negative electrode active material, and other procedures were the same as the respective procedures in Examples 1-1 to 1-6 and Comparative Example 1-1 to produce a respective beaker cell in Examples 2-1 to 2-6 and Comparative Example 2-1. The titanium composite oxide powders used as the negative electrode material had an average particle size of 0.8 μm, the BET specific surface area of 10 m²/g, and Li insertion potential of 1.5 V (vs. Li/Li⁺).

Subsequently, the same tests were conducted as described above for the beaker cells in Examples 2-1 to 2-6. The results are shown in the following Table 2.

TABLE 2

| | | Additive | Heating | Re- |
|---|---|---|---|---|
| | | amount | value | sistance |
| | Additive | [mass %] | [J/g] | ratio |
| Example 2-1 | trimethylsilyl isocyanate | 1.0 | 54 | 0.9 |
| Comparative | none | — | 214 | 1.0 |
| Example 2-1 | | | | |
| Example 2-2 | trimethylsilyl isothiocyanate | 1.0 | 60 | 0.9 |
| Example 2-3 | (trimethylsilyl)methyl | 1.0 | 64 | 1.0 |
| | isocyanate | | | |
| Example 2-4 | (trimethylsilyl)methyl | 1.0 | 68 | 1.0 |
| | isothiocyanate | | | |
| Example 2-5 | dimethyl silyl isocyanate | 1.0 | 105 | 1.0 |
| Example 2-6 | methyl silyl triisocyanate | 1.0 | 99 | 1.0 |

It is seen from the results shown in Table 2 that also in case where the titanium composite oxide having a spinel structure whose Li insertion/extraction potential of 1.5 V (vs. Li/Li⁺) was used as the negative electrode active material, by adding the silicon compound having the isocyanate group or the isothiocyanate group was added to the nonaqueous electrolyte, the heat generation when heated up to 200 degrees Celsius may be more suppressed than a case where the silicon compound was not added.

### Examples 3-1 to 3-6 and Comparative Example 3-1

Monoclinic system niobium composite oxide (TiNb₂O₇) powders were used as a negative electrode active material, and other procedures were the same as the respective procedures in Examples 1-1 to 1-6 and Comparative Example 1-1 to produce a respective beaker cell in Examples 3-1 to 3-6 and Comparative Example 3-1. The monoclinic system niobium composite oxide powders used as the negative electrode active material had an average particle size of 0.5 μm, the BET specific surface area of 15 m²/g, and Li insertion potential of 1.5 V (vs. Li/Li⁺).

Subsequently, the same tests were conducted as described above for the beaker cells in Examples 3-1 to 3-6 and Comparative Example 3-1. The results are shown in the following Table 3.

TABLE 3

| | | Additive | Heating | Re- |
|---|---|---|---|---|
| | | amount | value | sistance |
| | Additive | [mass %] | [J/g] | ratio |
| Example 3-1 | trimethylsilyl isocyanate | 1.0 | 61 | 0.8 |
| Comparative | none | — | 241 | 1.0 |
| Example 3-1 | | | | |
| Example 3-2 | trimethylsilyl isothiocyanate | 1.0 | 70 | 0.9 |
| Example 3-3 | (trimethylsilyl)methyl | 1.0 | 72 | 1.0 |
| | isocyanate | | | |
| Example 3-4 | (trimethylsilyl)methyl | 1.0 | 80 | 1.0 |
| | isothiocyanate | | | |
| Example 3-5 | dimethyl silyl isocyanate | 1.0 | 120 | 1.1 |
| Example 3-6 | methyl silyl triisocyanate | 1.0 | 116 | 1.1 |

It is seen from the results shown in Table 3 that also in case where the monoclinic system niobium composite oxide powders having a Li insertion/extraction potential of 1.5 V (vs. Li/Li⁺) was used as the negative electrode active material, by adding the silicon compound having the isocyanate group or the isothiocyanate group was added to the nonaqueous electrode, the heat generation when heated up to 200 degrees Celsius may be more suppressed than a case where the silicon compound was not added.

According to at least one Embodiment or Example as explained above, a nonaqueous electrolyte battery is supplied. This nonaqueous electrolyte battery may suppress decomposition of the nonaqueous electrolyte on the negative electrode surface if exposed under high-temperature conditions and may suppress the accompanying heat generation of the negative electrode, thanks to containing a negative electrode containing a negative electrode active material having a Li insertion/extraction potential of 0.4 V (vs. Li/Li⁺) or more and a nonaqueous electrolyte containing a silicon compound containing an isocyanate group or an isothiocyanate group.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A nonaqueous electrolyte battery comprising:
a positive electrode;
a negative electrode containing a negative electrode active material having a Li insertion/extraction potential of 0.4 V (vs. Li/Li⁺) or more; and
a nonaqueous electrolyte which is a liquid at 20 degrees Celsius and 1 atom, and contains a silicon compound having an isocyanate group or an isothiocyanate group.

2. The nonaqueous electrolyte battery according to claim 1, wherein a content of the silicon compound is 0.01 mass % to 5 mass % in the nonaqueous electrolyte.

3. The nonaqueous electrolyte battery according to claim 1, wherein the silicon compound has a trimethylsilyl group.

4. The nonaqueous electrolyte battery according to claim 1, wherein the silicon compound is trimethylsilyl isocyanate, trimethylsilyl isothiocyanate, (trimethylsilyl)methyl isocyanate or (trimethylsilyl)methyl isothiocyanate.

5. The nonaqueous electrolyte battery according to claim 1, wherein the Li insertion/extraction potential of the negative electrode active material is 1.0 V (vs. Li/Li⁺) or more.

6. The nonaqueous electrolyte battery according to claim 5, wherein the negative electrode active material is titanium composite oxide or niobium composite oxide.

7. The nonaqueous electrolyte battery according to claim 6, wherein the titanium composite oxide is a cubic crystal system spinel-type titanium composite oxide expressed by a general formula Li₄₊ₓTi₅O₁₂ (−1≦x≦3) or a monoclinic β type titanium composite oxide expressed by a general formula LiₓTiO₂ (0≦x≦1).

8. The nonaqueous electrolyte battery according to claim 6, wherein the niobium composite oxide is a monoclinic system niobium composite oxide expressed by a general formula LiₓM_{(1-y)}Nb_{y}Nb₂O_{(7+δ)} (in which M is at least one selected from a group consisting of Ti and Zr, and x, y and δ satisfy 0≦x≦6, 0≦y≦1 and −1≦δ≦1, respectively).

9. A battery pack comprising a nonaqueous electrolyte battery according to claim 1.

10. The battery pack according to claim 9, which comprises a plurality of the nonaqueous electrolyte batteries, and the batteries are electrically connected in series, in parallel or in combination thereof.

11. The battery pack according to claim 9, further comprising a protective circuit which can detect a voltage of the nonaqueous electrolyte battery.
